(19) United States
(12) Patent Application Publication
(10) Pub. No.: US 2003/0128175 A1
(43) Pub. Date: Jul. 10, 2003

(54) Stereoscopic display system and method

(75) Inventor: Viktors Berstis, Austin, TX (US)

Correspondence Address: Kelly K. Kordzik, 5400 Renaissance Tower, 1201 Elm Street, Dallas, TX, 75270, US

(73) Assignee: International Business Machines Corporation

(21) Appl. No.: 10/042,479

(22) Filed: Jan. 9, 2002

(51) Int. Cl. G09G 3/34

(52) U.S. Cl. 345/84

(57) ABSTRACT

A liquid crystal display (LCD) has an electro-mechanical structure over the surface of the display that enables the light from individual picture elements (pixels) to be directed by X and Y control signals. The electro-mechanical structure provides individual prism/lense elements over each pixel. The prism/lense element is configured so that light from the LCD may be directed towards each eye of a viewer. The prism/lense elements have a piezoelectric material integrated on a beam supporting the prism/lense element which may be energized with control signals to alter the angle of the prism/lense element so that the light may be selectively directed towards each eye of the viewer. Each piezoelectric element (PZE) has a positive and negative voltage terminal. One of the voltage terminals is “addressed” with an X line and the other with a Y line creating a matrix selection of each PZE. The voltage level of the X line may be varied to add further control of the PZE. If an X voltage is present and the corresponding Y return line is selected, then a PZE will deflect the particular prism/lense element. By alternatively presenting an image frame for each of the viewer's eyes and correspondingly controlling the pixels, a 3D image is perceived by the viewer. Adjustment is provided so that the level of the X voltages may be controlled by a viewer to personally optimize the display. Algorithms may be employed to control when particular pixels are activated and by how much so that anomalies in the display may be controlled.

### TECHNICAL FIELD

The present invention relates in general to an apparatus and methods for producing a viewable stereoscopic image from a two-dimensional display.

### BACKGROUND INFORMATION

When correctly implemented, stereoscopic three dimensional (3D) video displays may provide significant benefits in many application areas, including endoscopy and other medical imaging, remote-control vehicles and tele-manipulators, stereo 3D Computer Aided Design (CAD), molecular modeling, 3D computer graphics, 3D visualization, video-based training and entertainment.

Stereoscopic displays usually require the use of cumbersome glasses or other types of viewers. The display presents an image for the right eye and an alternate image for the left eye. A variety of viewing units, which correspond to the type of image displayed, are used to “fool” the brain into thinking it is observing a true 3D object. Some glasses are polarized and are used with corresponding polarized images. Polarization, while effective, may reduce the light that reaches each eye. Other techniques offer glasses that have electronic shutters such that the image for the left eye is blocked from the right eye and vice versa. Lenticular prism lenses have been used on specially prepared printed pictures and interlaced displays to simulate a 3D object. However, lenticular lenses are fixed, so there is no provision for adjusting for the viewer's position or for the distance between the viewer's eyes, which may result in ghost images or less than optimal viewing.

There is, therefore, a need for a method and a system that allows a user to view images on a display that has been adapted to present 3D images such that the viewer does not have to wear special glasses, and the viewer has adjustments that allow for variations in viewing distance and the viewer's own eye characteristics to be compensated.

### SUMMARY OF THE INVENTION

A display screen on which a back projected image is displayed is modified to incorporate an electro-mechanical structure that allows the light from each pixel to be selectively directed to a viewer's left and right eyes in response to control signals. A prism/lense element is provided for each pixel which may be selectively rotated so that light from the pixel may be directed to first one eye then to the other eye. X-Y control signals allow each prism/lense element to be individually addressed. The control signal for each pixel comprises X and Y voltages. If a voltage difference level is provided between particular X and Y lines, then the corresponding prism/lense element for the pixel is “addressed,” and the prism/lense element may be rotated changing the direction of the light from the pixel depending on the magnitude of the voltage. Single pixels or groups of pixels may be addressed at any one time. Whole image frames representing left and right eye views may be alternately presented for the left and right eyes of the viewer, or pixel data for left and right eye images may be selectively accessed from a memory device. When the left eye frame or left eye pixel data is present, the corresponding prism/lense elements are rotated by selectively applying control signals so that each left eye pixel is directed to the viewer's left eye. Likewise, when the right eye frame or right eye pixel data is present, the prism/lense elements are rotated by selectively applying control signals so that each right eye pixel is directed to the viewer's right eye. The levels of the control signals may be selectively controlled by algorithms to compensate for display anomalies and to allow a viewer to personalize the display. By selectively applying control signals synchronized with the particular displayed images, the viewer perceives a 3D presentation. One embodiment of the present invention uses piezoelectric elements to rotate the individual prism/lense elements. In another embodiment of the present invention, a prism/lense element may be designed to be rotated using electrostatic force.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram illustrating light from pixels being directed to a viewer's left and right eyes by prism/lense elements;

FIG. 2A and FIG. 2B illustrate an embodiment of the present invention where a piezoelectric element is used to deflect a beam supporting a prism/lense element;

FIG. 3 illustrates an X-Y addressing of individual pixels;

FIG. 4 illustrates an embodiment of the present invention for activating a piezoelectric element used to rotate prism/lense elements;

FIG. 5A and FIG. 5B illustrate an embodiment of the present invention for addressing an electrostatic element used to rotate a prism/lense element;

FIG. 6 illustrates various layers suitable for use in a micro-electronic mechanical (MEMS) process for making embodiments of the present invention;

FIG. 7A and FIG. 7B illustrate another embodiment of the present invention where a piezoelectric element is used to deflect a beam supporting a prism/lense element;

FIG. 8A, FIG. 8B and FIG. 8C illustrate another embodiment of the present invention with a piezoelectric element for rotating a prism/lense element; and

FIG. 9 is a block diagram of a data processing system suitable for operating a display with selectable prism/lense elements according to embodiments of the present invention.

FIG. 10 is a flow diagram of method steps for using embodiments of the present invention to display a 3D image.

### DETAILED DESCRIPTION

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

Most displays utilized on computer or television systems use techniques where the image impinges on the back side of a display screen and the light from the display screen is then received by a viewer's eyes. A cathode ray tube (CRT) uses electron beams to excite phosphors on the inside of the face of the CRT to generate various colors of light (photons), which in turn are received by the viewer's eyes. Other displays use various liquid crystal display (LCD) technologies to produce thin flat displays. Many of the LCDs are digital in that the individual picture elements (pixels) are addressable. Sometimes the switches that are used to address the individual pixels are integrated very close to each pixel using thin film transistor (TFT) technology.

While embodiments of the present invention may be usable with different types of displays, it is described herein with respect to the LCD technology, as this technology lends itself to processes where all the elements necessary for the display are integrated onto the LCD panel. The LCD technology is used in the following to further explain embodiments of the present invention; however, it is understood that the present invention is not limited to LCD displays.

Three dimensional (3D) displays have been described for many years. Most techniques comprise creating an image for the right eye and a separate image for the left eye and then using some means for directing the images to their corresponding eye. The 3D displays that generate entire images for the left and right eyes usually require some method to selectively mask the respective eyes when their image is not present. Glasses that have electronic shutters (e.g., using LCD techniques) are often used. Other techniques effectively break the image frame into strips, where alternating strips are obtained from the image for the right and left eyes. Lenticular prisms have been integrated on the face of such a display to direct the left frame strips to the left eye and the right frame strips to the right eye. Since each eye only receives half the frame, the image intensity and contrast may be sacrificed. These techniques also do not have an easy way of adjusting for the variations in an individual's viewing preferences.

Embodiments of the present invention use a directing element on individual pixels so an entire frame may be presented for each eye. In an embodiment of the present invention, the display screen is made using LCD display technology. Additional process steps are used to add electro-mechanical prism/lense element structures, which are addressable with “X” and “Y” voltage lines. Each prism/lense element is designed so that the X-Y voltage lines may be used to activate and then control a position of the prism/lense element so that the light of a pixel may be directed to the right or to the left eye. Since the prism/lense elements are individually controlled, different pixels may receive different levels of control so that viewing anomalies of a viewer display screen combination may be compensated or adjusted.

Frames of a display are presented to a viewer at a relatively slow rate. For example, video is presented at approximately 30 frames per second. As the frame presentation rate increases, less “flicker” is observed. Flicker occurs when the frame rate is such that a viewer is able to discern the individual frames changing. Since a prism/lense element of the present invention may be controlled individually, an entirely different 3D display methodology is possible. The image frames, which are arrays of digital data representing the intensity and color content of the individual pixels, may be stored in memory. A 3D display, according to an embodiment of the present invention, would supply a light value for each pixel corresponding to its left or right eye data and a control signal to the pixel indicating to which eye the pixel is directed. All the pixels for the image are not required to be directed to the left or right eye at any one time. Rather, the light value data from the memory may be randomly retrieved and supplied to the pixels. However, the rate at which the pixel data is supplied would be fast enough so that the viewer's eyes do not discern the individual pixels switching from right to left eye data. Embodiments of the present invention, where the light from individual pixels may be controllably switched from one eye to the other, allow many different possibilities in the control of image display.

If a frame of an image is presented for a time T before it changes, then for a time equal to T/2 the prism/lense elements will direct a left pixel light value to the left eye, and for a time T/2 the prism/lense elements will direct a right pixel light value to the right eye. If the prism/lense elements may be moved from a left orientation to a right orientation in a time T_{D}, the time T may be divided into T/T_{P}=K time slots. In this case T_{P}>>T_{D} to insure that the duration at a particular eye position is longer than the time to switch between eye positions. K/2 of these time slots are allotted for the left eye and K/2 for the right eye. During each of the K/2 time slots, light from half of the pixels are directed to the right eye and light from the other half are directed to the left eye. However, embodiments of the present invention allow a random allocation of which particular pixels in each K/2 time slot are directed to which eye. This may reduce the apparent flicker as seen be a viewer.

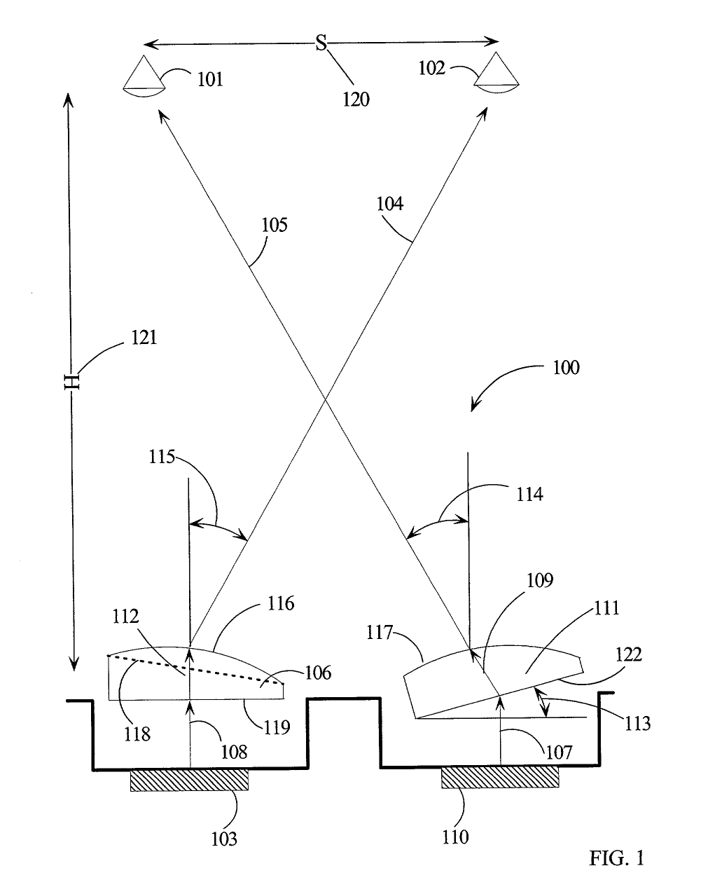

FIG. 1 illustrates two pixels 103 and 110 of a display 100. Pixel 103 has a prism/lense element (PL) 106 and pixel 110 has PL 111. Exemplary PL element 106 has a dashed line 118 identifying the area below the dashed line as its prism part and the curved surface 116 as its lense part. Dashed line 118 also shows that the lense surface 116 is at an angle with bottom surface 119. A light ray 108 from pixel 103 impinges perpendicular to the bottom surface 119. Because light ray 108 is perpendicular to bottom surface 119, its path as light ray 112 through the prism portion of PL 106 is not altered. However, when light ray 112 hits lense surface 116 the light is “bent” by angle 115 to the right towards a viewer's left eye 102. Initial light ray 108 is altered and results in light ray 104 which is directed towards the viewer's left eye. Left and right are referenced to the viewer's left and right sides.

The spacing S 120 between a typical viewer's eyes is approximately two inches, and the viewer's position H 121, relative to the display 100, is approximately twelve inches. A calculation shows that angle 115 would be in the range of five to ten degrees to direct a light ray towards left eye 102. The spacing between pixels 103 and 110 is greatly exaggerated to show detail. From a viewer's perspective, adjacent pixels 103 and 110 would be considered as nearly the same point source of light.

Pixel 110 has corresponding PL 111 which is shown rotated by an angle 113. PL 111 is rotated to show how a light ray 107 is directed to the left towards right eye 101. If PL 111 was in the same position as PL 106, light ray 107 would also be directed to the right. By rotating PL 111 by an angle 113, light ray 107 does not impinge perpendicular to the bottom surface 122 of PL 111, and Snell's law dictates that light ray 107 is “bent” proportional to the ratio of the indices of refraction of air and the material of PL 111. Light ray 107 follows a path shown by light ray 109 to the lense surface 117. Light ray 109 is then bent back to the right again, however the net result is that the original light ray 107 is directed to the right eye 101 as light ray 105. PL 111 may be rotated a sufficient angle 113 so that the resulting light ray angle 114 is equivalent to light ray angle 115.

The bending of light rays and the rotation of the prism/lense elements is the mechanism that directs the light rays towards a particular eye of a viewer. The lense portion of the prism/lense element serves to focus the light rays that strike the lense surfaces (e.g., lense surfaces 116 and 117) towards a central focal point. Light rays that are off center of PL 106 and PL 111 are directed to a light focal point. A viewer would not see much light with their right eye from pixels directed to their left eye and vice versa.

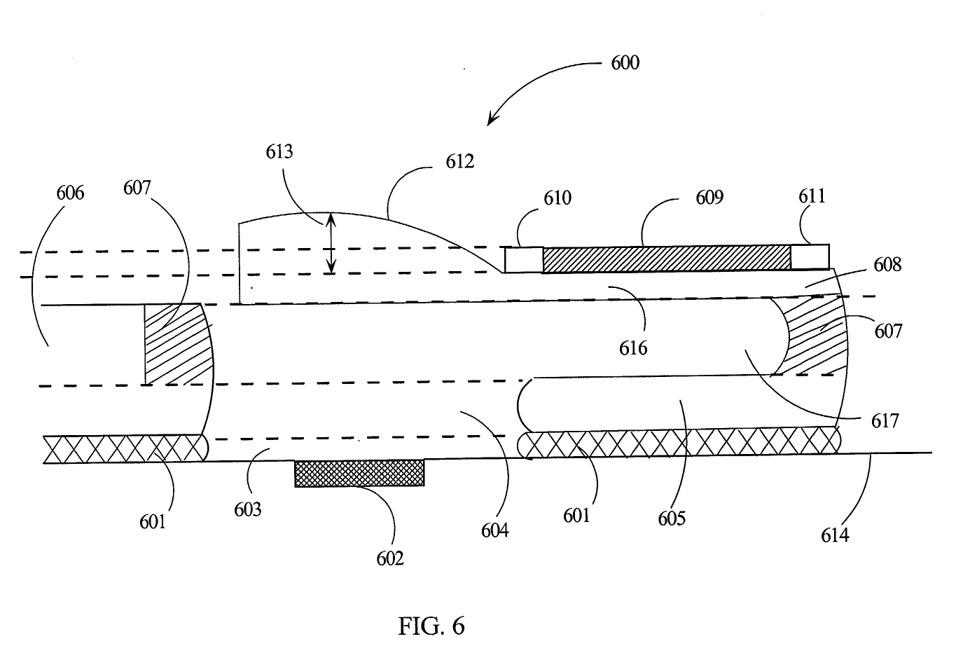

Exemplary elements PL 106 and PL 111 are complex structures, which may be integrated onto a display surface to enable compensated 3D image viewing. Details for fabricating prism/lense elements (e.g., PL 106 and PL 111) are discussed related to FIG. 6. A manufacturing method known as Micro-Electro-Mechanical Systems (MEMS) technology may be used in the process of fabricating an array of prism/lense elements according to embodiments of the present invention.

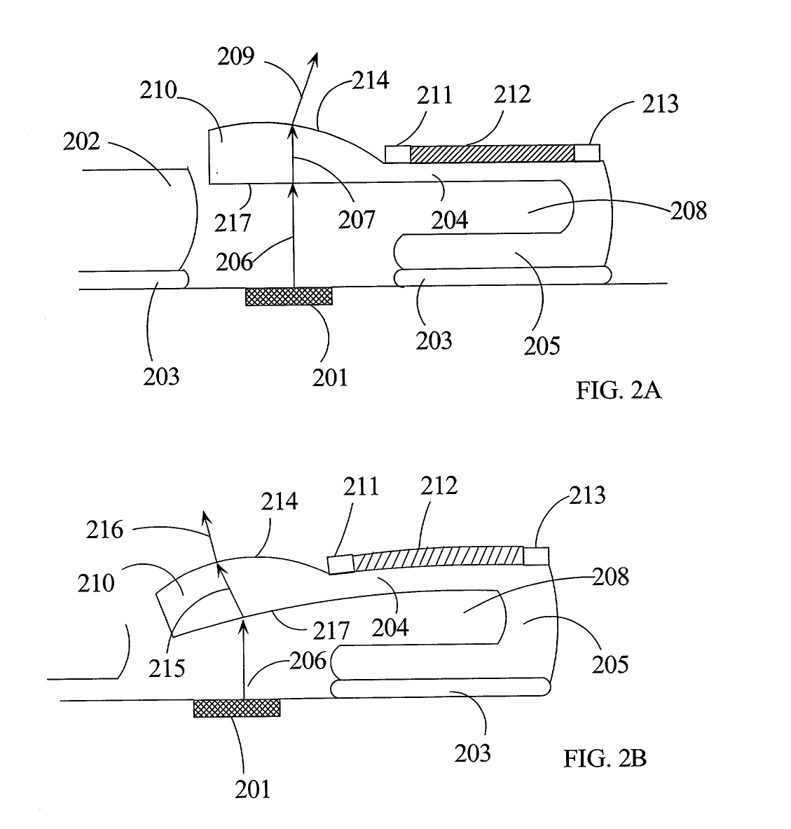

FIG. 2A and FIG. 2B illustrates a prism/lense element PL 210 for directing light from pixel 201. PL 210 is coupled to a beam 204 which in turn is coupled to base 205. Base 202 represents the base of another prism/lense element adjacent to PL 210 which is not completely shown. An opaque material layer 203 may be deposited around the opening to exemplary pixel 201 so that light from pixel 201 is directed primarily to PL 210. Material has been removed under PL 210 and beam 204 forming cavity 208. PL 210 is therefore free to move downwards towards pixel 201. A piezoelectric element (PZE) 212 has been formed on beam 204 with corresponding electrical contacts 211 and 213. A voltage may be applied across the length of PZE 212 which will cause voltage induced elongation (or contraction) stresses in beam 204. Since only one surface of PZE 212 is free to move, the voltage potential energy will be converted to a mechanical bending force that will bend beam 204 downwards thus causing a rotation and translation deflection in PL 210 as shown in FIG. 2B. In FIG. 2A, light ray 206 impinges perpendicular to surface 217 and follows path 207 to the surface 214 of the lense portion of PL 210. At surface 214 light ray 207 is bent to follow path 209 and is directed to the right. When PL 210 is rotated as shown in FIG. 2B, light ray 206 impinges on surface 217 at an angle and follows path 215 to surface 214. Again, light ray 215 is bent back to the right following path 216, however, the rotation of PL 210 has caused light ray 206 to have a net direction to the left. PL 210, as shown and controlled in FIG. 2A and FIG. 2B, is one embodiment of the present invention where the prism/lense element formed over a pixel is controlled by piezoelectric forces.

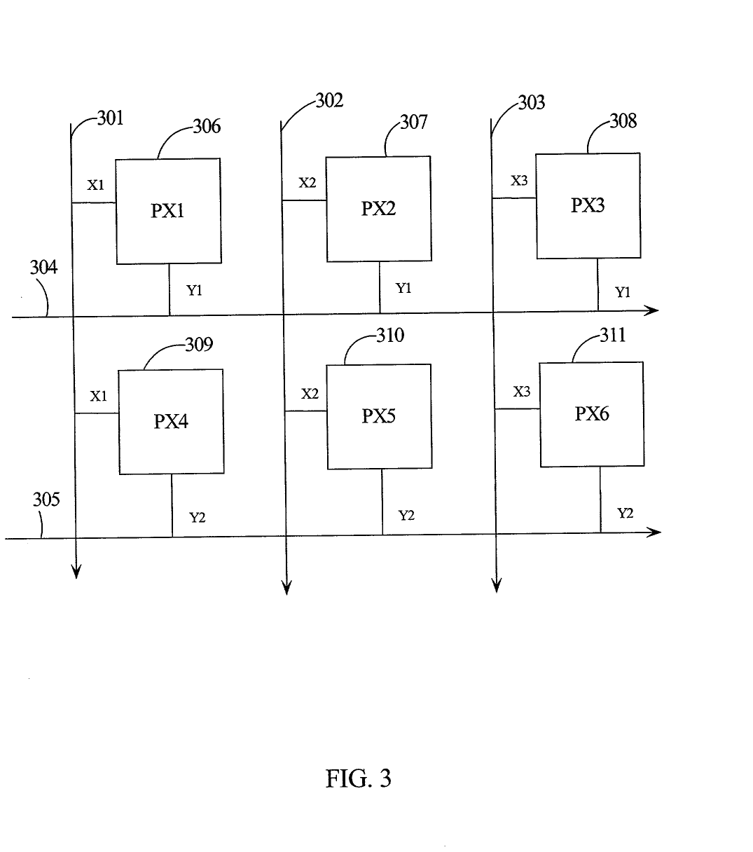

FIG. 3 illustrates a partial array of pixels 306-311. If the pixels 306-311 each have a voltage actuated prism/lense element (e.g., like PL 210), then selectively applying one potential of a voltage to X-lines 301-303 and the other potential to Y-lines 304-305 allows each pixel to be independently controlled. Y-lines 304-305 and X-lines 301-303 may be used to varying voltage levels such that the voltage difference between the X-Y line pairs are controlled in groups (e.g., rows or columns) or individually.

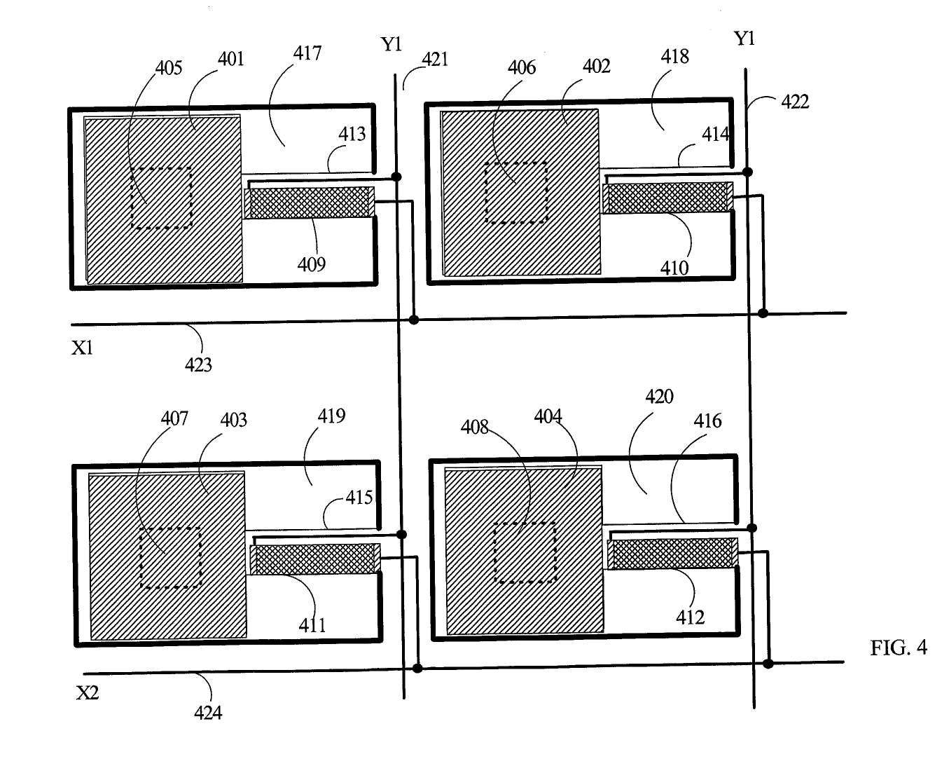

FIG. 4 illustrates a partial array of pixels 405-408 arranged as in FIG. 3 with corresponding prism/lense elements (PL) 401-404 which may be configured like PL 210 shown in FIG. 2A and FIG. 2B. PL 401-404 may be attached to corresponding beams 413-416 where beams 413-416 have corresponding piezoelectric elements PZE 409-412. Control voltage lines Y1 421, Y2 422, X1 423 and X2 424 are used to select and control PZE 409-412. X1 423 and X2 424 may be used to supply a ground and Y1 421 and Y2 422 may be used to supply the same or different voltage levels depending on the control algorithm used. The voltage across X-Y pairs may also be polarity reversed to cause piezoelectric elements (e.g., like PZE 409-412) to contract for additional control. Cavities 417-420 are similar to cavity 208 illustrated in FIG. 2A and FIG. 2B.

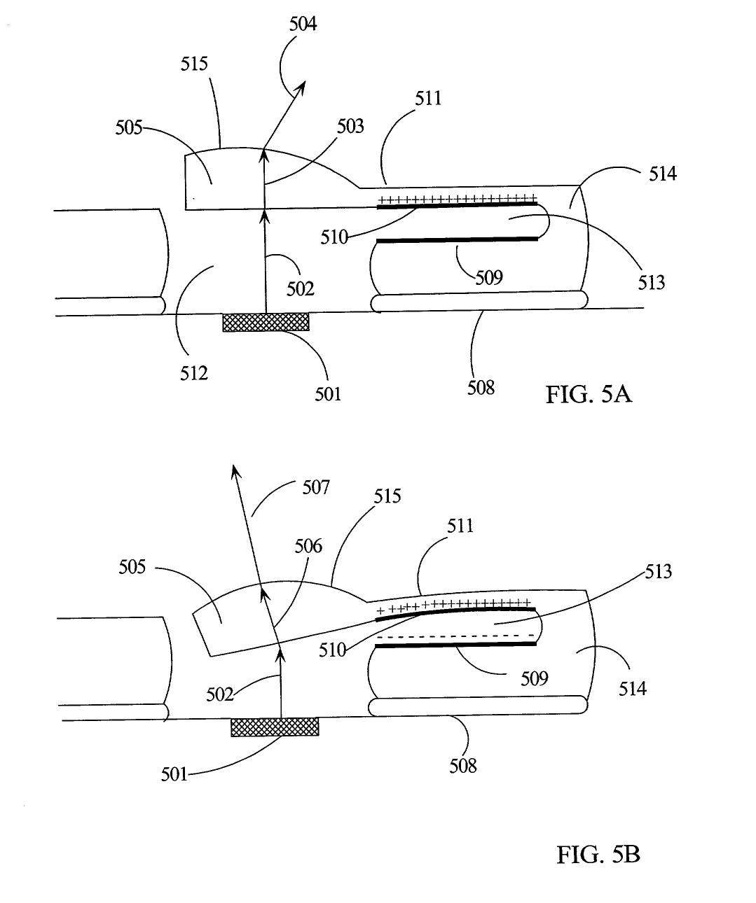

FIG. 5A and FIG. 5B illustrate another embodiment of the present invention where PL 505 is controlled by electro-static forces. PL 505 is coupled to beam 511 which extends over cavity 512. The underside of beam 511 has a metal layer 510 and the corresponding area under beam 511 on base 514 has a metal layer 509 which is isolated from layer 510. Opaque material 508 may be used to block light of pixel 501 from other than PL 505. Like PL 210 in FIG. 2A and FIG. 2B, PL 505 may be rotated by bending beam 511 in response to a control voltage addressing prism/lense element PL 505. When a voltage is applied across metal layers 510 and 509, the electrostatic forces will try to close gap 513. As the beams bends, the capacitance between the plates increases and energy is drawn from the source supplying the voltage to metal layers 510 and 509 to do the mechanical work. In this manner, a light ray 502 which normally follows a path 503 to path 504 (FIG. 5A) is deflected to follow path 506 and path 507 (FIG. 5B). Metal layers 510 and 509 may be connected to an X-Y addressing configuration as illustrated in FIG. 3 and FIG. 4.

FIG. 6 is used to illustrate one method by which a prism/lense element structure (PL) 600 may be fabricated using a MEMS process according to embodiments of the present invention. MEMS refers primarily to a process applied to semiconductor chips wherein a top layer of mechanical devices such as mirrors or fluid sensors are formed, however, the techniques may be applied to larger structures. In the research labs since the 1980s, MEMS devices began to materialize as commercial products in the mid-1990s. They are used to make pressure, temperature, chemical and vibration sensors, light reflectors and switches as well as accelerometers for air-bags, vehicle control, pacemakers and games. They are also used in the construction of micro-actuators for data storage as well as read/write heads, and they are used in all-optical switches to forward light beams by reflecting them to the appropriate output port.

Referring to FIG. 6, pixel 602 is representative of one of an array of pixels making up the face of a display modified according to embodiments of the present invention. In a first step in fabricating a prism/lense element 600, an opaque material 601 is deposited over substrate 614 which contains pixel element 602. A resist material (not shown) is then deposited over the opaque material 601 and then exposed and developed to allow a window 603 over pixel 602 to be opened using an appropriate etch material. A material layer 605, used to make PL 600, is then deposited. A resist material (not shown) is applied over layer 605 and exposed and developed so that an appropriate etch may be used to open window 603 and window 604. Next, a negative resist material is deposited in a layer 606. Layer 606 again fills up window areas 603 and 604. The negative resist material is formulated such that it must be exposed and developed before it becomes removable. If layer 606 has areas that are not exposed, then the material is not removable by a chemical etch. Layer 606 is exposed defining areas 607 and then the material in areas 607 is removed. The areas 607 are then filled with a material like layer 605. At this point, the remaining area of resist layer 606 is exposed so that it may be removed in a later step. Layer 608 is then deposited with the same material as layer 605. At this point layer 608, areas 607 and layer 605 are joined as like material. A resist layer (not shown) is then applied over layer 608 and a pattern is made so material for piezoelectric element 609 may be deposited. Another resist layer (not shown) is applied and another pattern is made so material for contacts 610 and 611 and contact lines coupled to contacts 610 and 611 may be deposited. Once piezoelectric element 609 is in place, another resist layer (not shown) is applied to a sufficient thickness such that the prism/lense element material may be deposited to a thickness 613 over material layer 608. The material for PL 600 is formulated as a negative resist material so that when exposed it may be etched. In formulating the lense surface 612 of PL 600, the intensity of the expose energy beam is adjusted so that the material of lense surface 612 is variably developed such that the material across the lense face 612 has different depths of development. When the material of PL 600 is etched, the lense surface 612 is formed as variable depth material is removed. In a last step, the previously exposed material in layer 606, under PL 612 and beam 616, is removed leaving PL 600 cantilevered over cavity 617. The process steps discussed relative to FIG. 6 represent one possible process for fabrication of PL 600 according to embodiments of the present invention. Other processes may be used to make controllable prism/lense elements (e.g., like PL 600) depending on materials selected for making various layers.

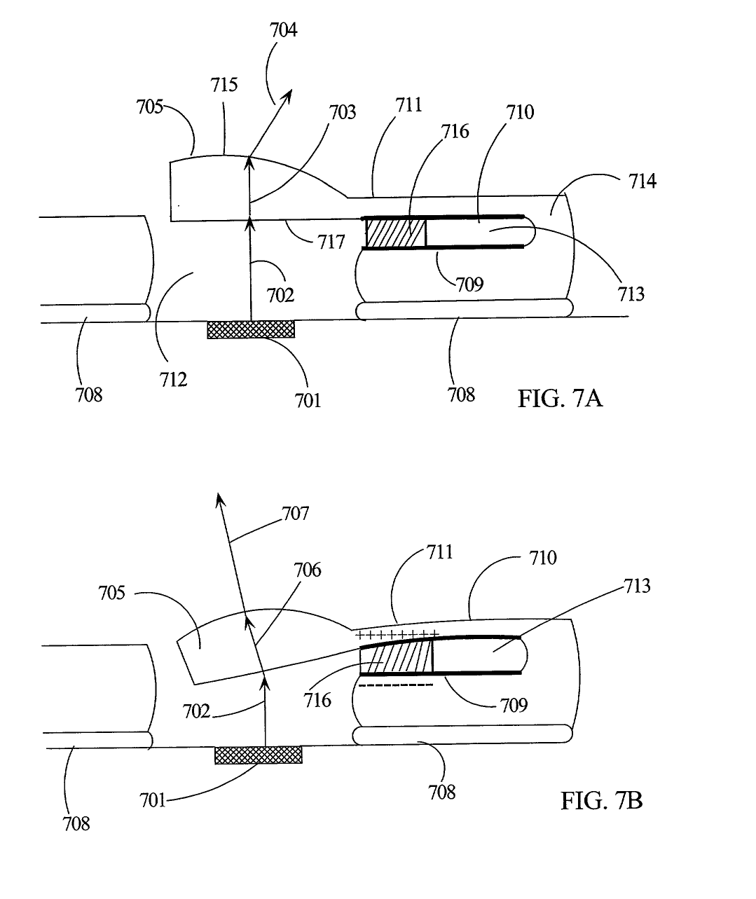

FIG. 7A and FIG. 7B illustrate another embodiment of the present invention using piezoelectric forces to control a prism/lense element. Pixel PL 705 is fabricated over pixel 701. Opaque layer 708 blocks light of pixel 701 from all but PL 705. In FIG. 7A, an exemplary light ray 702 impinges perpendicular to the bottom surface 717 of PL 705 and follows path 703 to lense surface 715 where light ray 703 is bent to follow path 704. PL 705 is supported on beam 711 attached to base 714. A gap 713 under beam 711 has PZE 716 with metal contacts 710 and 709. Contacts 710 and 709 allow a potential to be applied across PZE 716. Depending on the magnitude and polarity of the potential applied to contacts 710 and 709, PZE 716 will expand or contract, deflecting beam 711. In FIG. 7B, PZE 716 is shown contracted thereby deflecting beam 711 and PL 705 downwards toward pixel 701. As explained before, this causes light ray 702 to follow paths 706 and 707 whereby light from pixel 701 is directed to the left. Sequences of process steps like those explained in FIG. 6 may be used to fabricate PL 705, beam 711 and corresponding PZE 716 with contacts 710 and 709. Contacts 710 and 709 may be coupled to an X-Y addressing and control as shown in FIG. 3 and FIG. 4 and used with alternate left and right eye images to generate a 3D presentation. The magnitude of the voltage across contacts 710 and 709 may be varied to allow the deflection and rotation of individual pixels (e.g., 701) to be optimized for a particular viewer as explained within embodiments of the present invention.

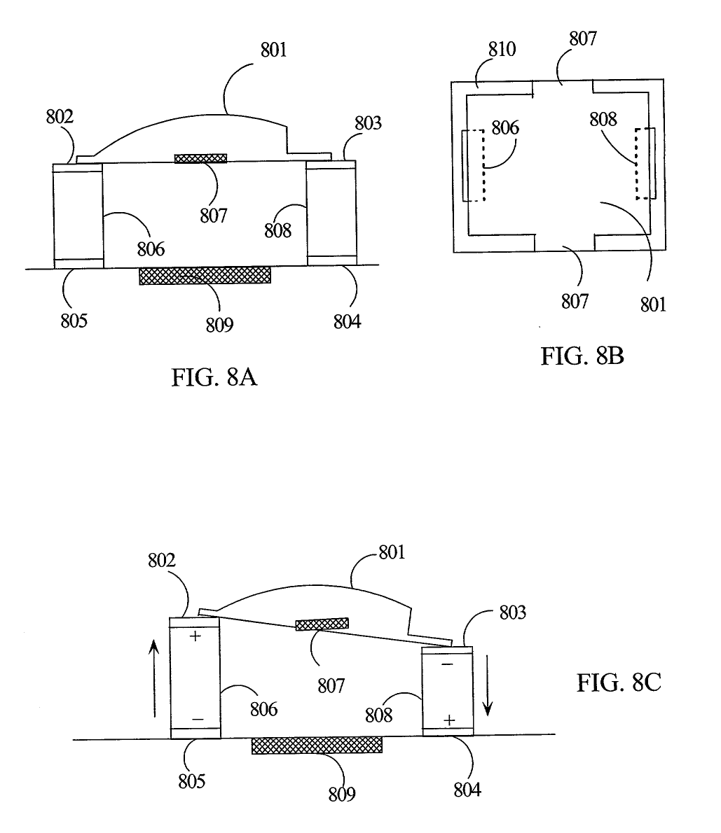

FIG. 8A, FIG. 8B and FIG. 8C illustrate another embodiment of the present invention. FIG. 8A is a side view of a PL 801 supported above a pixel 809. Piezoelectric elements (PZE) 806 and 808 support the edges of PL 801. PZE 806 has contacts 802 and 805 and PZE 808 has contacts 803 and 804. PL 801 is attached with an element 807 which is shown in a side view.

FIG. 8B is a top view of PL 801 illustrating how element 807 is attached to two sides of PL 801. Element 807 may be torsionally deflected to rotate PL 801 according to embodiments of the present invention.

FIG. 8C illustrates PL 801 rotated by applying voltages across PZE 806 and PZE 808. PZE 806 elongates and PZE 808 contracts and element 807 supporting PL 801 is twisted. The voltages applied to contacts 802-805 and 803-804 may be reversed to rotate PL 801 in the opposite direction. PL 801 may be fabricated with process steps like those discussed relative to FIG. 6.

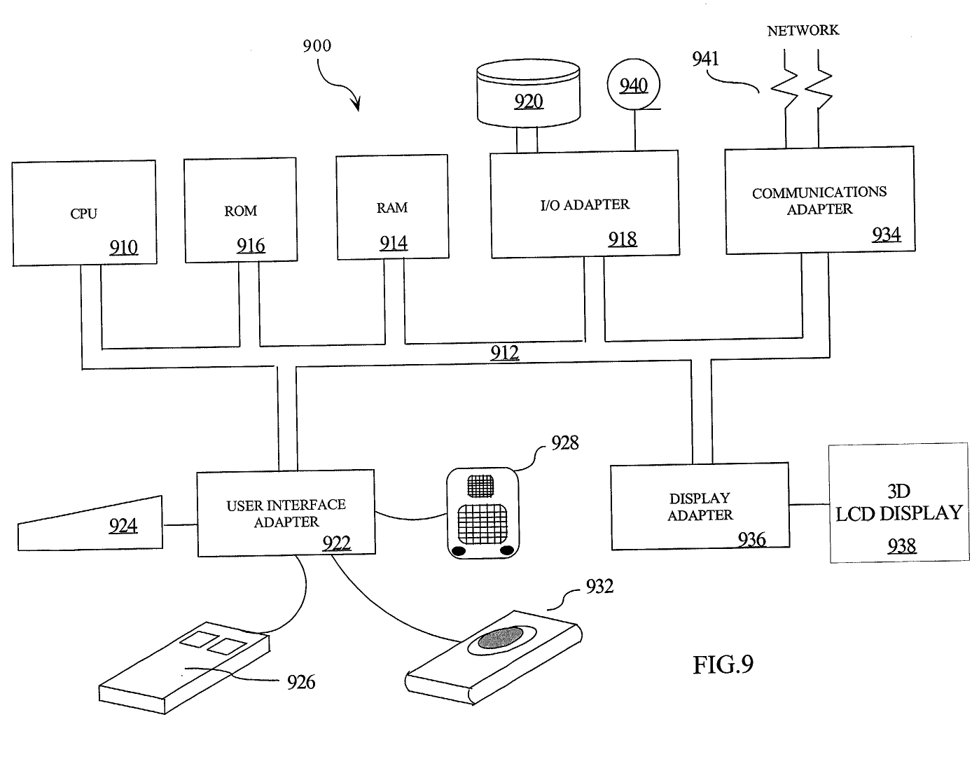

FIG. 9 is a high level functional block diagram of a representative data processing system 900 suitable for practicing the principles of the present invention. Data processing system 900, includes a central processing system (CPU) 910 operating in conjunction with a system bus 912. System bus 912 operates in accordance with a standard bus protocol, compatible with CPU 910. CPU 910 operates in conjunction with random access memory (RAM) 914. RAM 914 includes, DRAM (Dynamic Random Access Memory) system memory and SRAM (Static Random Access Memory) external cache. I/O Adapter 918 allows for an interconnection between the devices on system bus 912 and external peripherals, such as mass storage devices (e.g., a hard drive, floppy drive or CD/ROM drive) or a printer 940. A peripheral device 920 is, for example, coupled to a peripheral control interface (PCI) bus, and I/O adapter 918 therefore may be a PCI bus bridge. User interface adapter 922 couples various user input devices, such as a keyboard 924, mouse 926, trackball 932 or speaker 928 to the processing devices on bus 912. Display 938 which may be, for example, a cathode ray tube (CRT), liquid crystal display (LCD) or similar conventional display unit. Display adapter 936 may include, among other things, a conventional display controller and frame buffer memory. Data processing system 900 may be selectively coupled to a computer or telecommunications network 941 through communications adapter 934. Communications adapter 934 may include, for example, a modem for connection to a telecom network and/or hardware and software for connecting to a computer network such as a local area network (LAN) or a wide area network (WAN). A LCD display 938 may be fabricated according to embodiments of the present invention with integrated controllable prism/lense elements (e.g., like PL 505) over each pixel of LCD display 938. Software applications may utilize the advantage of LCD display 938 by alternately supplying left and right eye image frames. Control signals, synchronized with the image frames, may be used to present a 3D image to a viewer. Also control signals may be applied to selectively adjust the angle of prism/lense elements on LCD display 938 to optimize a viewer's presentation.

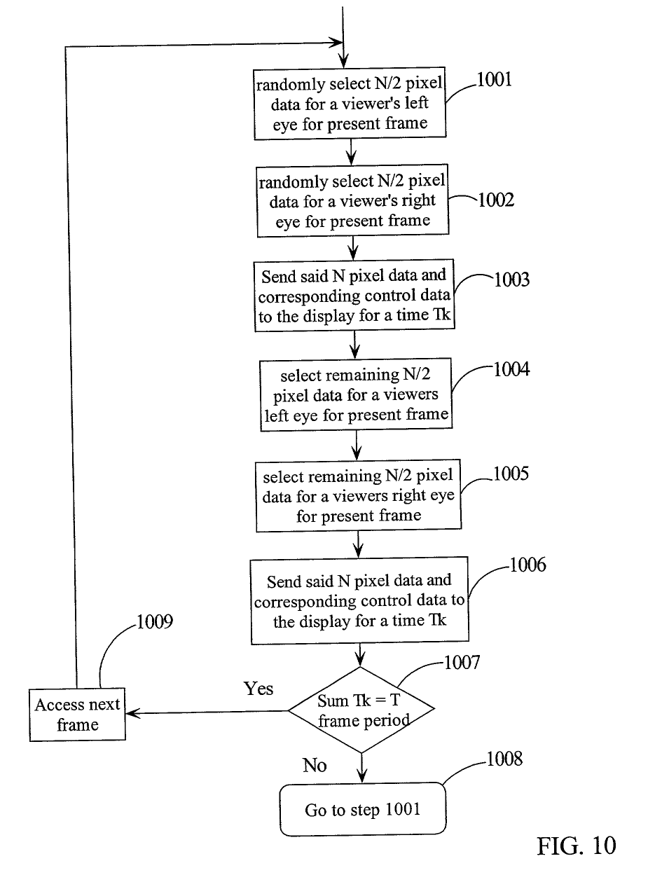

FIG. 10 is a flow diagram of method steps for displaying a stereoscopic 3D image using embodiments of the present invention. In step 1001, pixel data for N/2 pixels of N pixels defining a first image frame for a viewer's left eye are randomly selected. In step 1002, pixel data for N/2 pixels from N pixels defining the first image frame for a viewer's right eye are randomly selected. These N pixel data and corresponding control data for the optical elements corresponding to the selected pixel data are sent to the display for a time Tk in step 1003. In step 1004, the remaining N/2 data for the left eye view of the first image frame are selected and in step 1005 the remaining N/2 data for the right eye view of the first image frame are selected. In step 1006, these N pixel data are sent to the display for a time Tk. In step 1007, a test is done to determine if the sum of the time periods Tk equals an image frame time period T. If the sum of the times Tk equal the image frame time period T, then both the left and right views for the first image frame have been presented to the viewer for a time equal to the image frame period. When the left and right views have been displayed for a time equal to the image frame period T, the image frame data may change. In step 1009, the data for the next image frame is accessed and a branch to step 1001 starts another display sequence. If in step 1007 the sum of the Tk time periods do not equal the image frame period T, then the present image frame has not been displayed for the required time, and in step 1008 a branch is taken back to step 1001 where image frame data is again selected for the present frame.

Although the present invention and its advantages have been described in detail, it should be understood that various changes, substitutions and alterations can be made herein without departing from the spirit and scope of the invention as defined by the appended claims.

What is claimed is:

1. A method for producing a stereoscopic image from a display having N addressable pixels comprising the steps of:
generating N pixels of a first frame of an image directed to a view of an object a user experiences when said object is observed by said viewer's right eye;
generating N pixels of a second frame of said image directed to a view of said object a user experiences when said object is observed by said viewer's left eye;
receiving light from said N pixels in N optical elements for selectively directing light of said N pixels to said right eye in response to a first set of states of N corresponding control signals and to said left eye in response to a second set of states of said N control signals;
directing light from each of said N pixels of said first frame of said image to said right eye in a first time period by applying said first set of states of said N control signals to said N optical elements; and
directing light from said N pixels of said second frame of said image to said left eye in a second time period by applying said second set of states of said N control signals to said N optical elements.

2. The method of claim 1, wherein said first and second time periods corresponds to one half the period of a frame rate such that said first and second frames of said image of said object appear as a stereoscopic image to said viewer.

3. The method of claim 1 further comprising the step of:
selectively biasing said first and second sets of states of said N control signals to optimize said stereoscopic image perceived by said viewer.

4. The method of claim 1 further comprising the step of:
selectively adjusting biases of said first and second set of states to compensate for variations in said display.

5. The method of claim 1, wherein each of said N optical elements for selectively directing light of said N pixels of said image comprises:
a prism/lense element oriented over each of said N pixels and coupled to a piezoelectric element for modifying an orientation of said prism/lense element relative to each corresponding pixel of said display in response to one of said N control signals.

6. The method of claim 1, wherein said optical element for selectively directing light of said N pixels of said image comprises:
a prism/lense element oriented over each of said N pixels and coupled to an electrostatic element for modifying an orientation of said prism/lense element relative to a pixel of said display in response to one said N control signals.

7. The method of claim 5, wherein said piezoelectric element operates to bend a beam coupled to said prism/lense element.

8. The method of claim 6, wherein said electrostatic element bends a beam coupled to said prism/lense element.

9. The method of claim 5, wherein said piezoelectric element rotates said prism/lense element around a torsional support beam.

10. The method of claim 6, wherein said electrostatic element rotates said prism/lense element around a torsional support beam.

11. An apparatus for producing a stereoscopic image comprising:
a display comprising N addressable pixels for producing a first frame of an image directed to a view a user experiences when an object is observed by said viewer's right eye and producing a second frame of said image directed to a view said user experiences when said object is observed by said viewer's left eye;
N optical elements for selectively directing light from N pixels of said image to said right eye in response to a first set of levels of N control signals and to said left eye in response to a second set of levels of said N control signals;
circuitry for directing N pixels of said first frame of said image to said right eye in a first time period by applying said first set of levels of said N control signals to said N optical elements; and
circuitry for directing N pixels of said second frame of said image to said left eye in a second time period by applying said second set of levels of said N control signals to said N optical elements.

12. The apparatus of claim 11, wherein said first and second time periods correspond to one half the period of a frame rate such that said first and second frames of said image of said object appear as a stereoscopic image to said viewer.

13. The apparatus of claim 11 further comprising:
circuitry for selectively biasing said first and second sets of states of said N control signals to optimize said stereoscopic image perceived by said viewer.

14. The apparatus of claim 11 further comprising:
circuitry for selectively adjusting biases of said first and second set of states of said N control signals to compensate for variations in said display.

15. The apparatus of claim 11, wherein each of said optical elements for selectively directing light of said N pixels of said image comprises:
a prism/lense element oriented over each of said N pixels and coupled to a piezoelectric element for modifying an orientation of said prism/lense element relative to each corresponding pixel of said display in response to one of said N control signals.

16. The apparatus of claim 11, wherein each of said optical elements for selectively directing light of said N pixels of said image comprises:
a prism/lense element oriented over each of said N pixels and coupled to an electrostatic element for modifying an orientation of said prism/lense element relative to a pixel of said display in response to said N control signals.

17. The apparatus of claim 15, wherein said piezoelectric element operates to bend a beam coupled to said prism/lense element.

18. The apparatus of claim 16, wherein said electrostatic element bends a beam coupled to said prism/lense element.

19. The apparatus of claim 15, wherein said piezoelectric element rotates said prism/lense element around a torsional support beam.

20. The apparatus of claim 16, wherein said electrostatic element rotates said prism/lense element around a torsional support beam.

21. A data processing system comprising:
a central processing unit (CPU);
a random access memory (RAM);
a display adapter;
a display coupled to said display adapter; and
a bus system coupling said CPU to display adapter and said RAM, wherein said display further comprises;
N addressable pixels for producing a first frame of an image directed to a view a user experiences when an object is observed by said viewer's right eye and producing a second frame of said image directed to a view said user experiences when said object is observed by said viewer's left eye;
N optical elements for selectively directing light from N pixels of said image to said right eye in response to a first set of levels of N control signals and to said left eye in response to a second set of levels of said N control signals;
circuitry for directing N pixels of said first frame of said image to said right eye in a first time period by applying said first set of levels of said N control signals to said N optical elements; and
circuitry for directing N pixels of said second frame of said image to said left eye in a second time period by applying said second set of levels of said N control signals to said N optical elements.

22. The data processing system of claim 21, wherein said first and second time periods correspond to one half the period of a frame rate such that said first and second frames of said image of said object appear as a stereoscopic image to said viewer.

23. The data processing system of claim 21 further comprising:
circuitry for selectively biasing said first and second sets of states of said N control signals to optimize said stereoscopic image perceived by said viewer.

24. The data processing system of claim 21 further comprising:
circuitry for selectively adjusting biases of said first and second set of states of said N control signals to compensate for variations in said display.

25. The data processing system of claim 21, wherein each of said optical elements for selectively directing light of said N pixels of said image comprises:
a prism/lense element oriented over each of said N pixels and coupled to a piezoelectric element for modifying an orientation of said prism/lense element relative to each corresponding pixel of said display in response to one of said N control signals.

26. The data processing system of claim 21, wherein each of said optical elements for selectively directing light of said N pixels of said image comprises:
a prism/lense element oriented over each of said N pixels and coupled to an electrostatic element for modifying an orientation of said prism/lense element relative to a pixel of said display in response to said N control signals.

27. The data processing system of claim 25, wherein said piezoelectric element operates to bend a beam coupled to said prism/lense element.

28. The data processing system of claim 26, wherein said electrostatic element bends a beam coupled to said prism/lense element.

29. The data processing system of claim 25, wherein said piezoelectric element rotates said prism/lense element around a torsional support beam.

30. The data processing system of claim 26, wherein said electrostatic element rotates said prism/lense element around a torsional support beam.

31. A method for producing a stereoscopic display having N addressable pixels comprising the steps of:
1) randomly selecting, during a first time period Tk, N/2 pixels of N pixels of a first frame of an image directed to a view of an object a user experiences when said object is observed by said viewer's right eye;
2) selecting, during said first time period Tk, the remaining N/2 pixels of said N pixels of a second frame of said image directed to a view of said object a user experiences when said object is observed by said viewer's left eye;
3) receiving light from each of said N pixels in an optical element for selectively directing light of said N pixels to said right eye in response to a first set of states of N corresponding control signals and to said left eye in response to a second set of states of said N control signals;
4) directing light from said N/2 randomly selected pixels of said first frame of said image to said right eye in said first time period Tk by applying said first set of states of corresponding N/2 of said N control signals to said optical element for selectively directing said N pixels;
5) directing light from said N/2 remaining pixels of said second frame of said image to said left eye in said first time period Tk by applying said second set of states of said N control signals to said optical element for selectively directing said light of said N pixels; and
6) repeating said steps 1) through 5) until a sum of said repeated time periods Tk equals a second time period T corresponding to a frame rate of said image during which time data defining said image does not change.

32. The method of claim 31 further comprising the step of:
selectively biasing said first and second sets of states of said N control signals to optimize said stereoscopic image perceived by said viewer.

33. The method of claim 31 further comprising the step of:
selectively adjusting biases of said first and second set of states of said N control signals to compensate for variations in said display.

34. The method of claim 31, wherein each of said optical elements for selectively directing light of said pixels of said image comprises:
a prism/lense element oriented over each of said N pixels and coupled to a piezoelectric element for modifying an orientation of said prism/lense element relative to each corresponding pixel of said display in response to one said N control signals.

35. The method of claim 31, wherein each of said optical elements for selectively directing light of said pixels of said image comprises:
a prism/lense element oriented over each of said pixels and coupled to an electrostatic element for modifying an orientation of said prism/lense element relative to each corresponding pixel of said display in response to one of said N control signals.

36. The method of claim 34, wherein said piezoelectric element bends a beam coupled to said prism/lense element.

37. The method of claim 35, wherein said electrostatic element bends a beam coupled to said prism/lense element.

38. The method of claim 34, wherein said piezoelectric element rotates said prism/lense element around a torsional support beam.

39. The method of claim 35, wherein said electrostatic element rotates said prism/lense element around a torsional support beam.

40. An optical element for directing light from each pixel in an array of N pixels of a display comprising:
a prism/lense element having a flat first surface and a curved second surface and placed above and substantially parallel to said pixel;
a flexible beam coupled to said prism/lense element and placed above and parallel to said pixel; and
a piezoelectric element coupled to a surface of said flexible beam, said piezoelectric element having first and second voltage contacts integrated across an axis of elongation and contraction of said piezoelectric element, said first voltage contact coupled to a first control voltage and said second voltage contact coupled to a second control voltage.

41. The optical element of claim 40, wherein said prism/lense element is positioned relative to said pixel in response to voltage levels of said first and second control voltages causing said piezoelectric element to expand and contract thereby bending said flexible beam.

42. The optical element of claim 40, wherein said curved second surface of said prism/lense element focuses light from said pixel.

43. An optical element for directing light from a pixel in an array of N pixels of a display comprising:
a prism/lense element having a flat first surface and a curved second surface and placed above and substantially parallel to said pixel;
a flexible beam coupled to said prism/lense element and placed above and parallel to said pixel;
a first metallic surface placed on a surface of said flexible beam, said first metallic surface coupled to a first voltage; and
a second metallic surface placed parallel and opposing said first metallic surface, said second metallic surface coupled to a second voltage, said first and second metallic surfaces forming an electrostatic element with a gap between said first and second metallic surfaces.

44. The optical element of claim 43, wherein said prism/lense element is positioned relative to said pixel in response to voltage levels of said first and second control voltages causing said gap of said electrostatic element close thereby bending said flexible beam.

45. The optical element of claim 43, wherein said curved second surface of said prism/lense element focuses light from said pixel.

46. An optical element for directing light from a pixel in an array of N pixels of a display comprising:
a prism/lense element having a flat first surface and a curved second surface and placed above and substantially parallel to said pixel;
a flexible beam coupled to said prism/lense element and placed above and parallel to said pixel; and
a piezoelectric element coupled to a bottom surface of said flexible beam and to a stationary surface parallel and opposed to said flexible beam, said piezoelectric element having first and second voltage contacts integrated across an axis of elongation and contraction of said piezoelectric element, said first voltage contact coupled to a first control voltage and said second voltage contact coupled to a second control voltage.

47. The optical element of claim 46, wherein said prism/lense element is positioned relative to said pixel in response to voltage levels of said first and second control voltages causing said piezoelectric element to expand and contract thereby bending said flexible beam.

48. The optical element of claim 46, wherein said curved second surface of said prism/lense element focuses light from said pixel.

49. An optical element for directing light from a pixel in an array of N pixels of a display comprising:
a prism/lense element having a flat first surface and a curved second surface and placed above and substantially parallel to said pixel;
a torsional beam coupled to a first side of said prism/lense element suspending said prism/lense element substantially parallel to said pixel; and
a first piezoelectric element coupled to a second side of said prism/lense element, said second side parallel to an axis of said torsional beam, said first piezoelectric element having first and second voltage contacts coupled across an axis of expansion and contraction of said first piezoelectric element, said first and second voltage contacts coupled to first and second control voltages.

50. The optical element of claim 49, wherein said prism/lense element is positioned relative to said pixel in response to voltage levels of said first and second control voltages causing said first piezoelectric element to expand and contract thereby rotating said prism/lense element about said torsional beam.

51. The optical element of claim 49, wherein said curved second surface of said prism/lense element focuses light from said pixel.

52. The optical element of claim 49, wherein a second piezoelectric element is coupled to a third side of said prism/lense element, said third side parallel to said axis of said torsional beam, said piezoelectric element having third and fourth voltage contacts coupled across an axis of expansion and contraction of said second piezoelectric element, said third and fourth voltage contacts coupled to said first and second control voltages.

53. The optical element of claim 52, wherein said second piezoelectric element expands and contracts in opposition to said first piezoelectric element.

54. The optical element of claim 49, wherein a second torsional beam is coupled to a fourth side of said prism/lense element said fourth side parallel to and opposite said first side.
